(19) United States
(12) Patent Application Publication
(10) Pub. No.: US 2009/0063170 A1
(43) Pub. Date: Mar. 5, 2009

(54) METHODS AND SYSTEMS INVOLVING BUSINESS PROCESS MANAGEMENT

(75) Inventors: Jay W. Benayon, Thornhill (CA); Kui Yan Lau, Markham (CA); Humie Leung, Vancouver (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,976

(22) Filed: Aug. 29, 2007

(51) Int. Cl. G06Q 10/00

(52) U.S. Cl. 705/1

(57) ABSTRACT

A method for conducting business process parametric optimization, the method comprising generating a first set of cases in a business model, wherein the first set of cases represents all of the paths in the business model, generating a first set of parameters associated with the first set of cases of the business model, displaying the generated first set of cases, selecting a case from the first set of cases for optimization and simulation, generating a second set of parameters associated with the selected case, displaying the second set of parameters, simulating the selected case with the first set of parameters and the second set of parameters with a business process model simulator, and displaying resultant data from the business process model simulation of the selected case with the first set of parameters and the second set of parameters.

### BACKGROUND OF THE INVENTION

1. Field Of The Invention

This invention relates generally to business process management systems, and particularly to methods and systems involving business process parametric optimization.

2. Description Of Background

Business process management (BPM) uses modeling to analyze and optimize business processes parameters. A BPM model includes combinations of what-if scenarios organized into paths (cases). Each case represents a possible what-if scenario that may be encountered in the operation of a particular business process.

In complex business processes that include a large number of cases and parameters, the simulation engines use significant amounts of processing resources. The processing of large simulations may take a considerable amount of time. The processing time may reduce the ability of a user to effectively analyze and optimize a business process.

Thus, it is desirable to use a method and system in a BPM model that allows a user to decrease processing time and increase the usefulness of the resultant data from the model.

### SUMMARY OF THE INVENTION

The shortcomings of the prior art are overcome and additional advantages are achieved through an exemplary method for conducting business process parametric optimization, the method comprising generating a first set of cases in a business model, wherein the first set of cases represents all of the paths in the business model, generating a first set of parameters associated with the first set of cases of the business model, displaying the generated first set of cases, selecting a case from the first set of cases for optimization and simulation, generating a second set of parameters associated with the selected case, displaying the second set of parameters, simulating the selected case with the first set of parameters and the second set of parameters with a business process model simulator, and displaying resultant data from the business process model simulation of the selected case with the first set of parameters and the second set of parameters.

An exemplary alternate method for conducting business process parametric optimization, the method comprising generating a first set of cases in a business model, wherein the first set of cases represents all of the paths in the business model, generating a first set of parameters associated with the first set of cases of the business model, wherein the first set of parameters is generated by an optimizer, displaying the generated cases, selecting a case from the first set of generated cases for filtering following optimization and simulation, generating a second set of parameters associated with the selected case, displaying the second set of parameters, simulating the first set of cases with the first set of parameters and the second set of parameters with a business process model simulator, matching the first set of cases with resultant data from the business process model simulation associated with each case in the first set of cases, filtering the resultant data from the business process model simulation to include a set of data associated with the selected case, and displaying the set of data associated with the selected case.

An exemplary embodiment of a system for business process parametric optimization comprising, a business process model, a cases finder operative to generate all of the cases in the business process model, a simulator operative to simulate cases in the business process model and output resultant data, a cases selector operative to select a case generated from the business model and consolidate parameters related to the selected case and store the consolidated parameters in a cases information file, a simulation selector operative to determine whether the simulator will perform one of a first type of simulation and a second type of simulation, wherein the first type of simulation simulates only the selected case with parameters generated from all of the cases in the business process model and the second type of simulation simulates all of the cases of the business process model with parameters generated from all the cases in the business process model, a cases optimizer operative to responsive to the simulation selector determining that the simulator will perform the first type of simulation, optimize the parameters related to the selected case, update the parameters generated from all the cases in the business process model with the optimized parameters related to the selected case, and send the selected case and the updated parameters to the simulator for simulation, and responsive to the simulation selector determining that the simulator will perform the second type of simulation, optimize the parameters related to the selected case, update the parameters generated from all the cases in the business process model with the optimized parameters related to the selected case, and send all the cases in the business process model and the updated parameters to the simulator for simulation a cases filter responsive to the simulation selector determining that the simulator will perform the second type of simulation operative to receive the resultant data from the simulator and filter the resultant data corresponding to the selected case, and a cases matcher operative to associate the selected case with the filtered resultant data.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a diagram of an exemplary business process management parametric optimization system.

FIG. 2 illustrates an exemplary business process model.

FIG. 3 illustrates an exemplary embodiment of an output of a business process management parametric optimization system.

FIG. 4 illustrates an exemplary embodiment of an output of a business process management parametric optimization system.

The detailed description explains the preferred embodiments of the invention, together with advantages and features, by way of example with reference to the drawings.

### DETAILED DESCRIPTION OF THE INVENTION

Systems and methods involving business process management (BPM) models are provided. Several exemplary embodiments are described.

A BPM model includes combinations of what-if scenarios organized into paths (cases). Each case represents a possible what-if scenario that may be encountered in the operation of a particular business process.

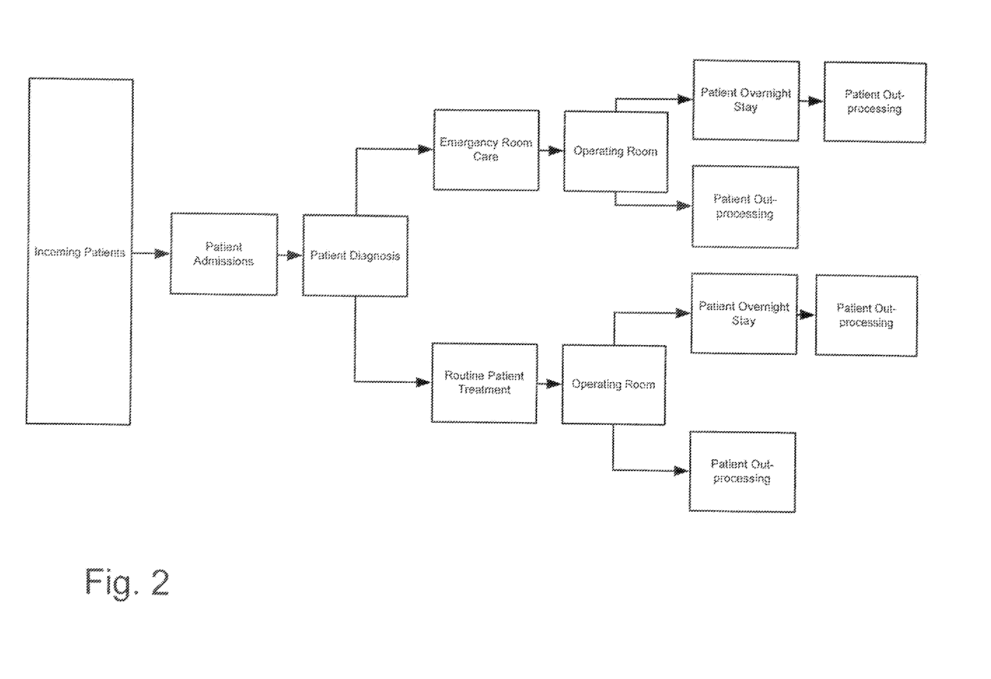

FIG. 2 illustrates an example of a hospital business process model, the model include tasks such as registration of a patient, the diagnosis of the symptoms of a patient, the treatment of the patient for the particular diagnosis, and the out-processing of the patient. Each business process includes decision points that branch out forming cases. Thus, a user may build a graphical representation of a business process that may include a number of cases that incoming patients will follow as they progress through their time at the hospital.

Each task in the process requires resources of the hospital, for example, doctor time, nurse time, administrative time, material costs, operating room time, etc. A user may organize the business process to include parameters including the resource requirements for each case and perform simulations of the business process to determine the overall performance of the business process. A user may vary the parameters for the resources available to the business process to analyze the process with regard to a particular business objective. For example, a user may increase the number of doctors and nurses available and determine the effect on business objectives such as patient waiting time and profitability.

Each task has parameters associated with the task such as, for example, the amount of time an administrator spends registering a patient and the amount of time a doctor takes to diagnose a patient. Other parameters may include, for example the probability of a patient following a particular case, the total number of operating rooms available, the total number of administrators available, the cost of medical supplies for each task, and the cost of each doctor.

A user may use the business process model to analyze the performance of the business process. For example, a user may be interested in determining the waiting time of patients in the model. A simulator may simulate the model and output the average waiting time of patients. The user may then optimize particular parameters to determine the effect on the waiting time of patients. For, example if the user increases the parameter for the total number of doctors, the simulator may rerun the simulation of the business process with a new set of parameters that includes the increased total number of doctors and output a new average waiting time of patients. The user may also be able to determine the effect of the increased number of doctors on other parameters such as an increase in the overall cost of doctors.

Additionally, a user may select a particular parameter or set of parameters for optimization. For example, a user may desire to optimize the patient waiting time. The optimizer will then vary the other parameters that may effect patient waiting time and send these parameters to the simulator for simulation. By varying the parameters sent to the simulator, the optimizer will determine which parameters may be changed to lower patient waiting time. Thus, the optimizer may show the user that an increase in the number of administrators may reduce the patient waiting time. The user may also determine the impact on other parameters such as profits if the number of administrators is increased.

Business process models may be very complex including hundreds of thousands of cases and parameters. Simulating a hospital, for example, may require thousands of patients to be processed through the simulation to analyze particular cases of interest. If, for example a user is interested in the cases related to a patient having radiation sickness, the probability of a patient having radiation sickness may be considerably lower than a patient having a laceration. Therefore, to analyze cases related to radiation sickness, a user must wait for the simulator to process enough patients such that cases related to radiation sickness are simulated.

Additionally, a user may only be interested in particular resultant data from cases of interest. Though a user may desire to run a simulation on an entire business process model, they may not be interested in receiving all of the resultant data from the entire simulation, but may only desire to receive information related to selected cases.

Thus, it is desirable for a business process model system to enable a user to select particular cases of interest for simulation and parameter optimization, thereby lowering the simulation time for processing the business process model. It is also desirable for a user to be able to select particular cases of interest and for the system to filter the resultant data from the simulation to only include resultant data related to the cases of interest, thereby simplifying the analysis of the resultant data from the simulation.

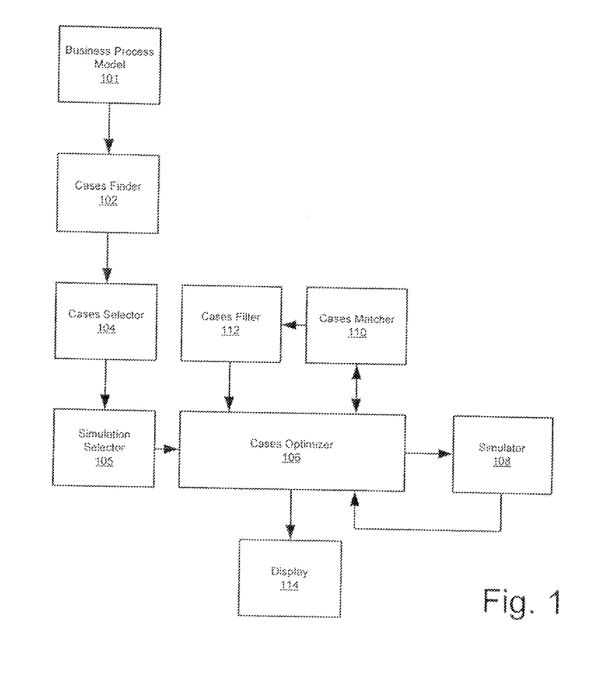

FIG. 1 illustrates an exemplary system for parametric optimization of business process models by cases. The exemplary system includes a business process model 101, a cases finder 102, a cases selector 104, a simulation selector 105, a cases optimizer 106, a simulator 108, a cases matcher 110, a cases filter 112, and a display 114.

In operation, a user develops a business process model 101 and including the parameters used in the model. The cases finder 102 generates all of the cases and parameters in the business process model 101 and sends all of the generated cases to the cases selector 104. The cases selector 104 allows the user to select one or more cases of interest from the cases generated by the cases finder 102.

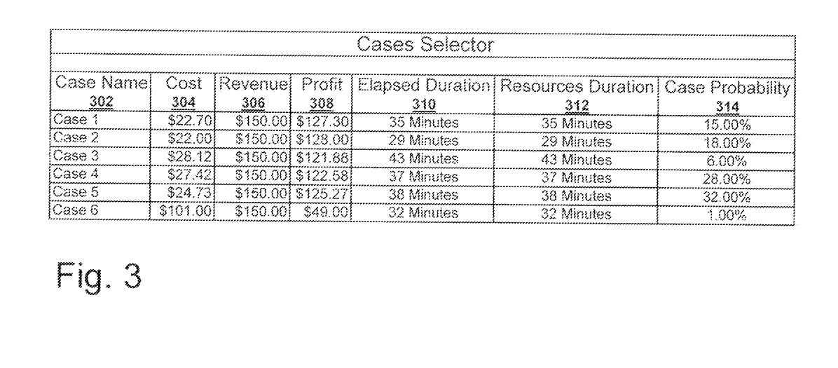

FIG. 3 illustrates an exemplary embodiment of a possible graphical output of the cases selector 105. Referring to FIG. 3, the cases finder 102 has generated six cases in the business process model. The cases selector 104 has output the names of the six cases (Case 1-Case 6) 302 and attributes of each of the cases, e.g. Cost 304, Revenue 306, Profit 308, Elapsed Duration 310, Resources Duration 312, and the probability of each case, Case Probability 314.

A user may select cases of interest from the list of cases in the cases selector 104. For example, a hospital business process model may include a case for radiation sickness that may be selected by the user. The cases selector 104 saves the selected cases and the parameters associated with the selected cases in a cases information file, and may also include all of the cases and the parameters associated with all of the cases from the entire business process model in the cases information file. The cases selector 104 may also present the generated cases in a manner directed by the user, such as, for example, sorting the cases to show the highest probable cases, the lowest probable cases, the most critical cases, and the least critical cases.

A cases optimizer 106 receives the cases information file and allows a user to select parameters from the business process model for optimization to meet business objectives. For example, a user may be interested in maximizing profits and minimizing patient waiting time. The cases optimizer sends cases and parameters to the simulator 108 for simulation. The parameters sent to the simulator 108 may include parameters from the entire business process model, parameters associated with the selected cases, and parameters associated with the parameters selected by the user for optimization. Simulation results are returned from the simulator 108 to the cases optimizer 106. The cases optimizer 106 may then repeatedly change the parameters sent to the simulator to compile data and determine from the compiled data optimal values for parameters that will optimize the desired business objectives.

A simulation selector 105 allows a user to select the type of simulation to be run on the simulator 108. The simulation selector 105 notifies the cases optimizer 106 to run either a first type of simulation or a second type of simulation on the simulator 108.

A first type of simulation simulates only the selected cases using all of the parameters generated by the cases finder 102 for the entire simulation. Thus, if a user is only interested in the case that involves ration sickness, the simulator 108 will run the selected case with all of the parameters in the business process model 101 (i.e. the total number of doctors available to the hospital and the total number of nurses) and the parameters associated with the cases selected for optimization. The first type of simulation effectively lowers the processing time of the simulator 108 and the cases optimizer 106 because a number of the cases and parameters in the business process model may not need to be simulated.

A second type of simulation simulates all of the cases in the business model and the parameters associated with the business process model 101 including the parameters associated with the parameters selected for optimization. The compiled data resultant from the simulation, is then matched by a cases matcher 110 such that the data is matched with each associated case. A cases filter 112 then filters the matched data to display only the matched data associated with the selected cases.

Thus, if a user selected the case involving radiation sickness in the cases selector 104, and the second type of simulation in the simulation selector 105, the cases optimizer 106 would send all of the cases, and all of the parameters to the simulator 108 for simulation. The case optimizer 106 would adjust selected parameters for optimization and compile data resultant from the simulation. Once the simulation is complete, or stopped by the user, the cases matcher 110 would match the cases with the resultant data from the simulation that is associated with each of the cases. The cases filter 112 then filters the matched cases such that the displayed resultant data only includes the data from the selected cases (e.g. the case involving radiation sickness). The second type of simulation allows a user to run the entire business process model 101, but allows them to limit their analysis to resultant data associated with the selected case, thereby simplifying and decreasing the time required for analysis.

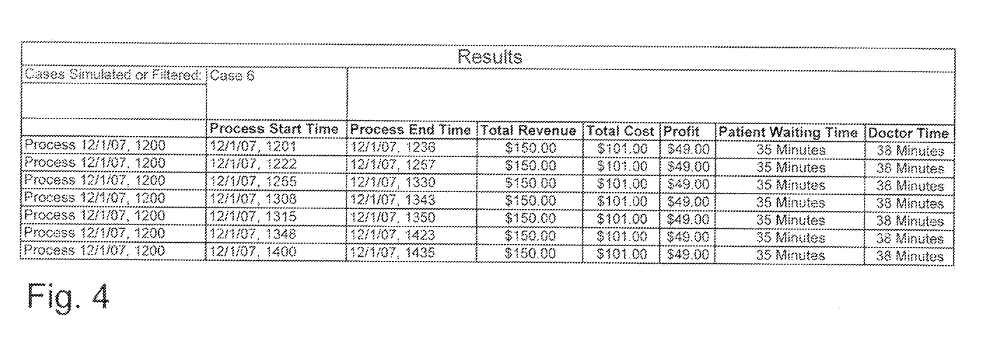

FIG. 4 illustrates an exemplary graphical output of the cases optimizer 106. In this example, the user has selected a case involving radiation sickness from the cases selector 104. The cases optimizer 106 has output data associated with the selected case. Referring to FIG. 4, the simulator 108 has run a number of simulations. The resultant data is displayed in a results display. The results display shows the cases simulated or filtered, the process start and end times for the simulation, the total revenue for the process, the total cost for the process, the profit for the process, the patient waiting time for the process, and the doctor time for the process. A user may use the data output by the cases optimizer to analyze the selected case. A user may then return to the cases optimizer 106 and change parameters of the selected case and run another simulation to continue the analysis.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for conducting business process parametric optimization, the method comprising:
generating a first set of cases in a business model, wherein the first set of cases represents all of the paths in the business model;
generating a first set of parameters associated with the first set of cases of the business model;
displaying the generated first set of cases;
selecting a case from the first set of cases for optimization and simulation;
generating a second set of parameters associated with the selected case;
displaying the second set of parameters;
simulating the selected case with the first set of parameters and the second set of parameters with a business process model simulator; and
displaying resultant data from the business process model simulation of the selected case with the first set of parameters and the second set of parameters.

2. The method for conducting business process parametric optimization of claim 1, the method further comprising:
responsive to displaying the second set of parameters, selecting a parameter from the displayed second set of parameters; and
responsive to selecting the parameter, changing the parameter.

3. The method for conducting business process parametric optimization of claim 1, the method further comprising:
selecting a plurality of cases from the generated first set of cases for optimization and simulation; and
generating a second set of parameters associated with the selected plurality of cases.

4. The method for conducting business process parametric optimization of claim 1, the method further comprising displaying the generated first set of cases in an order selected by a user.

5. A method for conducting business process parametric optimization, the method comprising:
generating a first set of cases in a business model, wherein the first set of cases represents all of the paths in the business model;
generating a first set of parameters associated with the first set of cases of the business model, wherein the first set of parameters is generated by an optimizer;
displaying the generated cases;
selecting a case from the first set of generated cases for filtering following optimization and simulation;
generating a second set of parameters associated with the selected case;
displaying the second set of parameters;
simulating the first set of cases with the first set of parameters and the second set of parameters with a business process model simulator;
matching the first set of cases with resultant data from the business process model simulation associated with each case in the first set of cases;
filtering the resultant data from the business process model simulation to include a set of data associated with the selected case; and
displaying the set of data associated with the selected case.

6. The method for conducting business process parametric optimization of claim 5, the method further comprising:
responsive to displaying the second set of parameters, selecting a parameter from the displayed second set of parameters; and
responsive to selecting the parameter, changing the parameter.

7. The method for conducting business process parametric optimization of claim 5, the method further comprising:
selecting a plurality of cases from the first set of generated cases for filtering following optimization and simulation;
generating a second set of parameters associated with the selected plurality of cases.

8. The method for conducting business process parametric optimization of claim 5, the method further comprising displaying the generated first set of cases in an order selected by a user.

9. A system for business process parametric optimization comprising:
a business process model;
a cases finder operative to generate all of the cases in the business process model;
a simulator operative to simulate cases in the business process model and output resultant data;
a cases selector operative to select a case generated from the business model and consolidate parameters related to the selected case and store the consolidated parameters in a cases information file;
a simulation selector operative to determine whether the simulator will perform one of a first type of simulation and a second type of simulation, wherein the first type of simulation simulates only the selected case with parameters generated from all of the cases in the business process model and the second type of simulation simulates all of the cases of the business process model with parameters generated from all the cases in the business process model; a cases optimizer operative to responsive to the simulation selector determining that the simulator will perform the first type of simulation, optimize the parameters related to the selected case, update the parameters generated from all the cases in the business process model with the optimized parameters related to the selected case, and send the selected case and the updated parameters to the simulator for simulation, and responsive to the simulation selector determining that the simulator will perform the second type of simulation, optimize the parameters related to the selected case, update the parameters generated from all the cases in the business process model with the optimized parameters related to the selected case, and send all the cases in the business process model and the updated parameters to the simulator for simulation;
a cases filter responsive to the simulation selector determining that the simulator will perform the second type of simulation operative to receive the resultant data from the simulator and filter the resultant data corresponding to the selected case; and
a cases matcher operative to associate the selected case with the filtered resultant data.
